(19) United States
(12) Patent Application Publication
(10) Pub. No.: US 2019/0216125 A1
(43) Pub. Date: Jul. 18, 2019

(54) METHODS THAT REDUCE FOOD CRAVINGS, PROMOTE WEIGHT LOSS, AND/OR TREAT OVERWEIGHT OR OBESITY

(71) Applicant: NESTEC S.A., Vevey (CH)

(72) Inventor: Martin Binks, Lubbock, TX (US)

(21) Appl. No.: 16/336,338

(22) PCT Filed: Sep. 28, 2017
(86) PCT No.: PCT/EP2017/074671

§ 371 Date: Mar. 25, 2019

Related U.S. Application Data
(60) Provisional application No. 62/401,568, filed on Sep. 29, 2016.

(51) Int. Cl. A23L 33/00; A23L 2/39; A23L 23/10

(52) U.S. Cl. CPC A23L 33/30; A23L 33/40; A23V 2002/00; A23L 23/10; A23L 2/39

(57) ABSTRACT

A method reduces food cravings, promotes weight loss, and/or treats overweight or obesity in a human in need thereof. The method includes orally administering meal replacements to the human each day of a time period of at least three weeks in an amount that provides a caloric intake of 800 to 1,500 kcal/day. The meal replacements are substantially the only food that contains calories consumed by the human during the time period. Each of the meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup. Preferably three to five of the meal replacements are administered to the individual daily during the time period.

### BACKGROUND

The present disclosure generally relates to methods that suppress food cravings, promote weight loss, and/or treat overweight or obesity. More specifically, the present disclosure relates to narrowing food stimuli by administering stimulus-restricted yet nutritionally-balanced meal replacements.

The prevalence of overweight and obesity are rising in the United States as well as globally (Caballero, Epidemiol. Rev. 29:1-5 (2007)). Long-term increased energy intake in excess of energy expenditure is a major contributor to obesity in the modern world (Berthoud, Neurosci. Biobehay. Rev. 26:393-428 (2002)). Food intake in the human body is maintained by a balance between energy homeostasis (i.e., the balance between energy intake and energy expenditure) and hedonic control (i.e., the influence exerted by the higher centers in the brain) (Berthoud, Appetite 43:315-17 (2004)). The hypothalamus and brain-stem receive inputs regarding the short-term and long-term energy status of the body and send inputs to higher centers in the brain that exert hedonic control. Learned experiences with food-related stimuli and emotions interact with reward pathways which collectively determine the degree of ‘liking’ of a food.

The ultimate need to have food (termed ‘wanting’) is calculated based on the homeostatic need, plus the degree of ‘liking’ and executive control. To better understand these relationships, functional magnetic resonance imaging (fMRI) has been utilized to examine the effects of short-term calorie restriction (typically 24-48 hour total fasting) on the neural circuitry associated with ingestive behavior.

However, weight control is typically attempted in the real world in the context of calorie restriction over periods of weeks and months in order to induce and maintain weight loss. This approach is typically achieved through reducing the amount or type of food consumed (i.e., reduction of portion sizes or eating less calorie-dense foods) or through replacement of meals with commercially available liquid preparations (nutritionally balanced total meal replacement products); both of which have been shown to be effective in weight loss (Jensen et al., J. Am. Coll. Cardiol. 2013).

Individuals who succeed in losing weight and maintaining the weight lost through portion-size reduction approaches have been shown to have a high degree of hedonic restraint (Sweet et al., Obesity 20:2220-5 (2012)). However, calorie restriction through reducing the amount of food consumed seems to be associated with increased subjective hunger and craving for food. The latter may lead to high failure and relapse rates compared to replacement of meals with nutritionally balanced meal replacement products. Furthermore, low-calorie meal replacement formulations have been shown to reduce hunger and craving for food even after food is re-introduced (Martin et al. 14:115-21 (2006). A comparison of hedonic reactions to foods (i.e., food-cue reactivity) between long-term food-based calorie restriction and laparoscopic gastric banding procedure indicated that food-based calorie restriction is associated with increased food-cue reactivity in the cortical areas exerting hedonic executive control over ingestive behavior (Bruce et al., Obesity 22:337-43 (2014)). Increased hedonic restraint, as evidenced by increased restraint scores and increased food-cue reactivity in the pre-frontal cortex, was seen in subjects who are successful in losing weight via interventions that implement food-based calorie restriction (McCaffery et al., Am. J. Clin. Nutr. 90:928-34 (2009)). Nevertheless, differences in neurophysiological mechanisms of action of nutritionally balanced total meal replacement over a period of several weeks have not been studied using an fMRI paradigm.

### SUMMARY

The present inventor recognized that much of the relatively limited work using fMRI to study brain regions of interest (ROIs) activation related to food-cue reactivity in people with obesity has focused on very brief total fasting paradigms (8-48 hours). Furthermore, very little has been done to examine connectivity patterns between the brain regions involved in controlling ingestive behavior. The present inventor sought a better understanding of these processes as they relate to more commonly used dietary interventions required and developed a study to work toward a complete understanding or the diet-brain relationship.

As discussed in more detail later herein, a randomized controlled clinical trial used a Food-Cue Reactivity fMRI paradigm to determine if participation in a 3-week, low calorie diet (1,120 kcal) derived entirely from OPTIFAST™ 800 total meal replacement shakes (Total Meal Replacement; TMR) differentially influences brain regions of interest pertaining to hunger, satiety, craving and reward as compared to a portion-controlled, naturalistic, 1,120 kcal diet derived from foods typically consumed by participants (Typical Diet; TD).

The present inventor surprisingly found that TMR increases the food-cue reactivity of the brain regions that regulate food reward compared to TD, but concurrent increases in the activity of regions that exert executive control were also noted. Thus the net short-term effect of TMR is a suppression of overall food cravings and also greater ultimate reduction in body weight and BMI compared to TD.

Accordingly, in a general embodiment, the present disclosure provides a method of method of reducing food cravings, promoting weight loss, and/or treating overweight or obesity in a human in need thereof. The method comprises orally administering meal replacements to the human each day of a time period comprising at least three weeks in an amount that provides a caloric intake of 800 to 1,500 kcal/day. The meal replacements are substantially the only food that contains calories consumed by the human during the time period. Each of the meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup.

In an embodiment, the human is overweight. The human can be obese.

In an embodiment, the meal replacements are administered to the human in an amount that provides a caloric intake of 1,000 to 1,300 kcal/day during the time period.

In an embodiment, the time period in which the meal replacements are administered each day is at least one month.

In an embodiment, three to five of the meal replacements are administered to the individual daily during the time period.

In an embodiment, each of the meal replacements provides 100 to 300 kcal to the human.

In an embodiment, each of the meal replacements provides 8 to 30 g of protein to the human.

In an embodiment, each of the meal replacements provides 10 to 30 g of carbohydrate to the human.

In an embodiment, each of the meal replacements provides 2 to 5 g of fat to the human.

In an embodiment, each of the meal replacements provides to the human 10% to 40% of the RDI of each of vitamins and minerals comprising Vitamin A, Vitamin C, Calcium, Iron, Vitamin D, Vitamin E, Vitamin K, Thiamin, Riboflavin, Niacin, Vitamin B6, Folate, Vitamin B12, Biotin, Pantothenic Acid, Phosphorus, Iodine, Magnesium, Zinc, Selenium, Copper, Manganese, Chromium, Molybdenum, and Chloride. In an embodiment, each of the meal replacements consists essentially of fat, protein, carbohydrates, the vitamins and the minerals.

In another embodiment, the present disclosure provides a kit for reducing food cravings and/or narrowing food stimuli. The kit comprises separately packaged meal replacements, and the kit further comprises instructions identifying a daily number of the separately packaged meal replacements to consume to provide a daily caloric intake of 800-1,500 kcal/day. The kit comprises a number of the separately packaged meal replacements that is sufficient to provide the daily number of the separately packaged meal replacements for at least three weeks.

The number of the separately packaged meal replacements in the kit can be sufficient to provide the daily number of the separately packaged meal replacements for at least one month. The daily number of the separately packaged meal replacements to consume to provide the daily caloric intake of 800-1,500 kcal/day can be in the range of three to five. Each of the separately packaged meal replacements can have a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup. Each of the separately packaged meal replacements can provide 100 to 300 kcal.

In other embodiments, the present disclosure provides a method of narrowing food stimuli, a method of promoting ingestive restraint and/or increased control over ingestive behavior, and a method of preventing relapse after caloric restriction. Each of these methods comprise orally administering meal replacements to a human each day of a time period comprising at least three weeks in an amount that provides a caloric intake of 800 to 1,500 kcal/day. The meal replacements are substantially the only food that contains calories consumed by the human during the time period. Each of the meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup.

Additional features and advantages are described herein and will be apparent from the following Figures and Detailed Description.

### DETAILED DESCRIPTION

### Definitions

Some definitions are provided hereafter. Nevertheless, definitions may be located in the “Embodiments” section below, and the above header “Definitions” does not mean that such disclosures in the “Embodiments” section are not definitions.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “a component” or “the component” includes two or more components.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive.

The terms “food,” “food product” and “food composition” mean a product or composition that is intended for ingestion by an individual such as a human and provides at least one nutrient to the individual. As used herein, these terms encompass food in any form, including both liquid (e.g., a beverage) and solid. The compositions of the present disclosure, including the many embodiments described herein, can comprise, consist of, or consist essentially of the elements disclosed herein, as well as any additional or optional ingredients, components, or elements described herein or otherwise useful in a diet.

A “meal replacement” is a food composition administered and consumed by itself, without any other food composition. Preferably a meal replacement is administered and consumed at least one hour after and/or at least one hour before any other food composition (e.g., another meal replacement), more preferably at least two hours after and/or at least two hours before any other food composition, and most preferably at least three hours after and/or at least three hours before any other food composition. As set forth in European Union Commission Directive 96/8/EC of 26 Feb. 1996, meal replacements can be divided in two categories: (a) products presented as a replacement for the whole of the daily diet (“total diet replacement”) and (b) products presented as a replacement for one or more meals of the daily diet (“meal replacement”).

“Prevention” includes reduction of risk and/or severity of a condition or disorder. The terms “treatment,” “treat,” “attenuate” and “alleviate” include both prophylactic or preventive treatment (that prevent and/or slow the development of a targeted pathologic condition or disorder) and curative, therapeutic or disease-modifying treatment, including therapeutic measures that cure, slow down, lessen symptoms of, and/or halt progression of a diagnosed pathologic condition or disorder, and include treatment of patients at risk of contracting a disease or suspected to have contracted a disease, as well as patients who are ill or have been diagnosed as suffering from a disease or medical condition. The term does not necessarily imply that a subject is treated until total recovery. These terms also refer to the maintenance and/or promotion of health in an individual not suffering from a disease but who may be susceptible to the development of an unhealthy condition. These terms are also intended to include the potentiation or otherwise enhancement of one or more primary prophylactic or therapeutic measure. The terms “treatment,” “treat,” “attenuate” and “alleviate” are further intended to include the dietary management of a disease or condition or the dietary management for prophylaxis or prevention a disease or condition. A treatment can be patient- or doctor-related.

“Overweight” is defined for a human as a BMI between 25 and 30 kg/m². “Obese” is defined for a human as a body mass index (BMI) of at least 30 kg/m², for example 30-39.9 kg/m². “Weight loss” is a reduction of the total body weight. Weight loss may, for example, refer to the loss of total body mass in an effort to improve one or more of health, fitness or appearance.

As used herein, an “effective amount” is an amount that prevents a deficiency, treats a disease or medical condition in an individual or, more generally, reduces symptoms, manages progression of the diseases or provides a nutritional, physiological, or medical benefit to the individual. The relative terms “promote,” “improve,” “increase,” “enhance” and the like refer to the effects of the method disclosed herein which comprises administering meal replacements, relative to a diet of natural foodstuffs (e.g., fruits, vegetables, meats, grains, nuts, beans) but identical in daily caloric intake.

The Recommended Daily Intake (RDI) of vitamins and minerals is established by Title 21 of the Code of Federal Regulations, Volume 2 (revised Apr. 1, 2015), Chapter I, Subchapter B, Part 101, Subpart A, Section 101.9 (“Nutrition labeling of food”), subsection (c)(8)(iv). In this regard, the RDI is established for the vitamins and minerals as follows:

Vitamin A: 5,000 International Units

Vitamin C: 60 milligrams

Calcium: 1,000 milligrams

Iron: 18 milligrams

Vitamin D: 400 International Units

Vitamin E: 30 International Units

Vitamin K: 80 micrograms

Thiamin: 1.5 milligrams

Riboflavin: 1.7 milligrams

Niacin: 20 milligrams

Vitamin B6: 2.0 milligrams

Folate: 400 micrograms

Vitamin B12: 6 micrograms

Biotin: 300 micrograms

Pantothenic acid: 10 milligrams

Phosphorus: 1,000 milligrams

Iodine: 150 micrograms

Magnesium: 400 milligrams

Zinc: 15 milligrams

Selenium: 70 micrograms

Copper: 2.0 milligrams

Manganese: 2.0 milligrams

Chromium: 120 micrograms

Molybdenum: 75 micrograms

Chloride: 3,400 milligrams

### EMBODIMENTS

An aspect of the present disclosure is a method of reducing food cravings, promoting weight loss, and/or treating overweight or obesity in a human in need thereof (e.g., an overweight or obese human). The method comprises orally administering to the human one or more meal replacements daily for a time period of at least three weeks in an amount that provides a caloric intake of 800-1,500 kcal/day, preferably 900-1,400 kcal/day, more preferably 1,000-1,300 kcal/day, and most preferably about 1,120 kcal/day. In some embodiments, the one or more meal replacements are administered to the human daily for a time period of at least one month, at least two months or at least three months.

The composition is administered as multiple separate meal replacements per day, preferably at least three separate meal replacements per day, more preferably at least four separate meal replacements per day, most preferably five separate meal replacements per day.

The one or more meal replacements administered daily are substantially the only food containing calories consumed by the human during the time period (i.e., during the time period, the human obtains approximately all of their nutrition from the one or more meal replacements, for example a “total diet replacement” according to European Union Commission Directive 96/8/EC). As noted above, “food” includes beverages; but coffee, water and diet sodas (i.e., low or no calorie sodas) are considered foods that do not contain calories according to the present disclosure. “Substantially the only food or beverage containing calories consumed by the human during the time period” means that the human consumes less than 200 kcal daily from food or beverages other than the meal replacements disclosed herein, preferably less than 100 kcal daily, more preferably less than 50 kcal daily, most preferably about zero kcal daily.

Preferably the human has an age of 19-60 years from birth. In some embodiments, the human is otherwise healthy, i.e., overweight or obesity is the only disorder or condition afflicting the human. In some embodiments, the human does not consume weight loss medication (e.g., Orlistat, Phentermine+Topiramate, Lorcaserin, Bupropion+Naltrexone, or Liraglutide) during the time period.

Preferably each of the one or more meal replacements has a form individually selected from the group consisting of a ready-to-drink beverage, a concentrate designed to be diluted to a beverage, a powder designed to be reconstituted as a beverage, a soup, a concentrate designed to be diluted to a soup, a powder designed to be reconstituted as a soup, or a nutrition bar. A “beverage” is a substantially homogenous liquid that is at least 85 wt. % water, in some embodiments at least 90 wt. % water or at least 95 wt. % water. A “ready-to-drink” beverage is in a liquid form that can be consumed without further addition of liquid and preferably is aseptic. Reconstitution and dilution can comprise addition of water and/or milk to the powder or concentrate respectively, and in some embodiments the method comprises a reconstitution or dilution step.

In some embodiments, each of the meal replacements comprises 100 to 300 kcal, preferably 125 to 250 kcal, more preferably 150 to 200 kcal, most preferably about 160 kcal; protein in an amount of 8-30 g, preferably 10 to 20 g, more preferably 12 to 15 g, most preferably about 14 g; carbohydrates in an amount of 10 to 30 g, preferably 15 to 25 g, more preferably 18 to 22 g, most preferably about 20 g; and fat in an amount of 1 to 7 g, preferably 1 to 6 g, more preferably 2 to 5 g, most preferably about 3 g. These amounts are per unit (e.g., per separately packaged ready-to-drink beverage, per separately packaged nutrition bar, per separately packaged soup, per serving of powder designed to be reconstituted, or per serving of concentrate designed to be diluted).

In some embodiments, each of the meal replacements comprises sodium in an amount of 100 to 500 mg, preferably 200 to 250 mg; however, the meal replacement in soup form can comprise sodium in an amount of 500 to 750 mg, preferably 600 to 620 mg. In some embodiments, each of the meal replacements comprises potassium in an amount of 250 to 750 mg, preferably about 470 mg. In some embodiments, each of the meal replacements comprises vitamins and minerals in an amount of 10% to 40% of the RDI, for example 10 to 30% of the RDI or 20% to 30% of the RDI, and preferably comprises this amount for each of Vitamin A, Vitamin C, Calcium, Iron, Vitamin D, Vitamin E, Vitamin K, Thiamin, Riboflavin, Niacin, Vitamin B6, Folate, Vitamin B12, Biotin, Pantothenic Acid, Phosphorus, Iodine, Magnesium, Zinc, Selenium, Copper, Manganese, Chromium, Molybdenum, and Chloride.

The protein can be milk, e.g., fluid milk, milk powder, skim milk (for example fluid skim milk and/or non-fat dry skim milk), ultra-filtered milk, buttermilk, milk protein concentrate, or milk protein isolate; whey, e.g., native whey, intact unhydrolyzed whey, whey protein concentrate, whey protein isolate, acid whey, sweet whey, modified sweet whey (sweet whey from which the caseino-glycomacropeptide has been removed), a fraction of whey protein, or whey protein hydrolysate; casein; a vegetable protein such as soy protein; and combinations thereof. The casein may be provided in free form or in the form of a salt, for example, a sodium salt, a calcium salt or a potassium salt. Although the protein can comprise vegetable protein, the composition is preferably gluten-free. In a preferred embodiment, each of the meal replacements comprises sodium caseinate and/or calcium caseinate.

The protein may be extensively hydrolyzed protein hydrolysates prepared from acid or enzyme treated animal and vegetable proteins, such as casein hydrolysate, whey hydrolysate, casein/whey hydrolysate, soy hydrolysate, and mixtures thereof. “Extensively hydrolyzed” protein hydrolysates means that the intact protein is hydrolyzed into peptide fragments in which a majority of the peptide fragments have a molecular weight less than 1,000 Daltons, preferably at least about 75% and most preferably at least about 95% of the peptide fragments having a molecular weight less than about 1,000 Daltons. Free amino acids and synthetic short peptide chains may be substituted for or added to the protein hydrolysates.

In an embodiment, the protein comprises whey protein micelles as described in U.S. Patent App. Pub. No. 2009/0035437 and its counterpart EP1839492A1 and as further characterized in C. Schmitt et al., Soft Matter 6:4876-4884 (2010) where they are referred to as whey protein microgels (WPM). Particularly, whey protein micelles are the micelles comprised in the whey protein micelles concentrate obtained by the process as disclosed in U.S. Patent App. Pub. No. 2009/0035437 and its counterpart EP1839492A1. Therein, the process for the production of whey protein micelles concentrate comprises the steps of: a) adjusting the pH of a whey protein aqueous solution to a value between 3.0 and 8.0; b) subjecting the aqueous solution to a temperature between 80 and 98° C.; and c) concentrating the dispersion obtained in step b). Thereby, the micelles produced have an extremely sharp size distribution, such that more than 80% of the micelles produced have a size smaller than 1 micron in diameter and preferably are between 100 nm and 900 nm in size. The whey protein micelles can be in liquid concentrate or in powder form. Importantly, the basic micelle structure of the whey proteins is conserved, whether in the liquid concentrate form, the powder form, or reconstituted from the powder, for example in water. The whey protein micelles are physically stable in dispersion, as a powder as well as during spray-drying or freeze-drying.

Non-limiting examples of suitable carbohydrates include starch, sucrose, lactose, glucose, fructose, corn syrup solids, maltodextrin, modified starch, amylose starch, tapioca starch, corn starch, xylitol, sorbitol or combinations thereof. In a preferred embodiment, each of the meal replacements comprises corn syrup solids and/or fructose.

Non-limiting examples of suitable lipids include vegetable fat (such as olive oil, corn oil, sunflower oil, high-oleic sunflower, rapeseed oil, canola oil, hazelnut oil, soy oil, palm oil, coconut oil, blackcurrant seed oil, borage oil, lecithins, and the like), animal fats (such as milk fat), or combinations thereof. The source of fat may also be less refined versions of these fats (e.g., olive oil for polyphenol content). In a preferred embodiment, each of the meal replacements comprises high oleic sunflower oil and/or canola oil.

In some embodiments, each of the meal replacements comprises one or more antioxidants to maintain freshness, such as butylated hydroxyanisole (“BHA”) and butylated hydroxytoluene (“BHT”). In embodiments in which each of the meal replacements is a ready-to-drink beverage, each of the meal replacements preferably comprises at least one stabilizing component selected from the group consisting of cellulose, carrageenan, and an emulsifier such as lecithin (e.g., soy lecithin). In some embodiments, each of the meal replacements comprises one or more colorings and/or one or more flavorings. Preferably each of the meal replacements has an identical nutritional formulation relative to the other meal replacements, although different colorings and different flavorings (e.g., vanilla, chocolate and/or strawberry flavoring) are still encompassed by this embodiment.

In another aspect of the present disclosure, a kit comprises separately packaged meal replacements (e.g., the meal replacements disclosed herein). The kit comprises instructions identifying a daily number of the separately packaged meal replacements to consume to provide a daily caloric intake of 800-1,500 kcal/day, preferably 900-1,400 kcal/day, more preferably 1,000-1,300 kcal/day, and most preferably about 1,120 kcal/day. For example, the instructions can identify that the daily number of the separately packaged meal replacements to consume is five meal replacements. The kit comprises a number of the separately packaged meal replacements that is sufficient to provide the daily number of the separately packaged meal replacements for at least three weeks, preferably at least one month.

As used herein, including the appended claims, a “kit” means that the identified components are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be one or more containers that contain the identified components, and the one or more containers are physically associated such that they are considered a unit for manufacture, distribution, sale or use. A “sachet” is a small disposable bag or pouch, for example made of cellophane.

### EXAMPLE

The following non-limiting example is illustrative of methods for reducing food cravings and promoting weight loss, in embodiments provided by the present disclosure.

### Example 1

The inventor's clinical experience indicated a frequently observed phenomenon involving patient-reported reduction in and/or the amelioration of food cravings, along with a general reduction in interest and focus on food shortly (2-3 weeks) after initiating balanced nutrition total meal replacement weight loss interventions. These anecdotal reports, while not universal, occurred in a large subset of program participants. The inventors observed these effects in multiple programs in varied settings at caloric levels ranging from 800-1,500 kcal/day.

Little empirical research has examined this phenomenon. A few small studies had documented a reduction in self-reported craving using paper and pencil measures in response to low caloric meal replacement-based diets but much remained to be understood regarding the existence of and or mechanisms involved. For example, it was unclear whether the reduction in craving was due largely to reduced attention to food stimuli, decreases in food-related reward, increases in self-regulatory capacity, or some unique property of the nutritional product that was yet to be identified.

The present inventors recognized that advances in fMRI application provide an opportunity to better understand the neural pathways involved in ingestive behavior. Essentially, fMRI technology allows for the creation of visual representations of the brain regions that are active during the performance of a given task and thus provides a methodology to better understand the neural pathways involved in appetite regulation, satiety, food reward and food craving. Several such brain regions have been implicated in this regard, including the hypothalamic-cortical pathways involved in evaluating food stimuli in relation to nutritional status: orbitofrontal, anterior cingulate and insular cortical areas, nucleus accumbens and ventral striatum involved in the expectation and evaluation of reward; hippocampus and amygdala involved in association of food cues with long-term memories and associated affective states; and also medial and dorsolateral prefrontal cortex involved in the evaluation of stimulus relevance within the social, cognitive and affective states of the individual.

A common model used to study these relationships is the food-cue reactivity paradigm which involves visual presentation of food-related stimuli to participants while they undergo an fMRI scan, thus allowing investigators to ‘see’ how the brain is responding to various food cues. To date, the majority of this research has been conducted in the context of complete food deprivation by comparing ‘fed versus fasted⋅ states’ within 8-48 hour periods. As such, the next translational step is to expose participants to a slightly longer stimulus-restricted yet nutritionally balanced diet for direct comparison with a typical food-based diet.

Interestingly, individuals who succeed in losing weight and maintaining the weight that is lost have been shown to have a high degree of hedonic restraint. However, the inventors' review of the literature uncovered no studies that consider changes in food-cue reactivity involving longterm caloric restriction, particularly in the context of nutritionally balanced total meal replacement-based diets. Thus, the study disclosed herein represents a novel investigation that examined selective neural activation and interconnectivity of regions and pathways known to be involved in appetite, reward, appetitive motivation, and reactivity to food cues while participants undergo a brief calorie-restricted nutritionally balanced total meal replacement.

A randomized controlled clinical trial used a Food-Cue Reactivity fMRI paradigm to determine if participation in a 3-week, low calorie diet (1120 kcal) derived entirely from the OPTIFAST™ 800 total meal replacement shakes (Total Meal Replacement; TMR) differentially influences brain regions of interest pertaining to hunger, satiety, craving and reward as compared to a portion controlled, naturalistic, 1120 kcal diet derived from foods typically consumed by participants (Typical Diet; TD).

Thirty-two subjects (age 19-65 years; BMI 30-39.9 kg/m²; Female 56%) were enrolled. Subjects were excluded who had a clinical history that may affect the primary variables of interest or safety (e.g. irregular menstruation, diabetes mellitus, uncontrolled hypertension, cardiovascular disease, neurological illness, eating disorders, severe psychopathology, current or past suicidal ideation, history of or current substance abuse, participation in a weight loss program in the last 3 months, history of bariatric surgery, contraindications for MRI).

Subjects were randomized into 2 groups with each prescribed a diet of 1,120 kcal/day (3 weeks) by 1) OPTIFAST™ 800 total meal replacement shakes (TMR) or 2) portion-reduced typical food (TD). Baseline and post intervention weight, BMI, body fat, Food-Craving Inventory (White et al., Obes. Res., 10(2):107-114 (2002)) and fMRI scans were obtained. An event-related visual food-cue reactivity fMRI task (food vs. object) was employed with pre/post change in body fat and duration of pre-scan fasting as covariates. MRI data were examined for artifacts, preprocessed and analyzed using the FLAME-1 algorithm in FSL (FMRIB Software Library, Version 5.0, Oxford, UK) using pre/post change in body fat and duration of pre-scan fasting as covariates and subsequent cluster thresholding using a permutation-based approach (randomise function) in FSL.

Regarding the fMRI scanning paradigm, an event-related design was used for all stimulus presentations. 120 images of two categories (food items and objects) were displayed on an LCD screen and projected via a mirror attached to the head coil. Images of food and objects were matched for contrast, brightness, size and resolution. Food images represented a continuous spectrum of highly rewarding to less rewarding items, while selected common objects (e.g. a paper clip) were deemed ‘neutral.’ Each participant was shown a fixation cross lasting for 2000-4000 ms. Then each visual image was presented for 5000-6000 ms with ‘overlapped’ opportunity for rating of the stimulus by the subject (i.e., ratings performed while viewing the image).

During the presentation of each image, participants were required to answer the question “How much do you want it now?” on a 1-7 Likert scale using fiber optic buttons. This sequence was conducted 30 times, with different images to complete each run. Eight such runs comprised each scanning session. Following the stimulus presentation phase (EPI scan), a T1-weighted structural scan (SS) lasting approximately 5 minutes was obtained followed by a diffusion tensor imaging (DTI) scan (6 minutes) to assess white-matter connectivity.

fMRI analysis was be carried out using a standard mixed effects model implemented in FMR113 Software Library (FSL). Specifically, analysis of fMRI data was focused on identifying pre-post differences in both the location and relative magnitude of whole brain activation patterns within and between members of each group (TMR vs. TD). Pre-planned comparisons were also made for specific ROIs: a) food-reward related areas (e.g. insula, orbito-frontal cortex. anterior cingulate cortex. and amygdala): b) reward calculating regions (e.g., nucleus accumbens and ventral siriatum), c) memory and emotion related areas (e.g. hippocampus and amygdala), d) homeostatic circuitry (i.e., hypothalamus) and cortical areas exerting executive control (e.g., pre-frontal cortex). Both structural and functional connectivity between the considered ROIs were also modeled and compared between and within groups. Demographic, health, weight history and psychosocial variables were included as covariates in specific analyses as indicated.

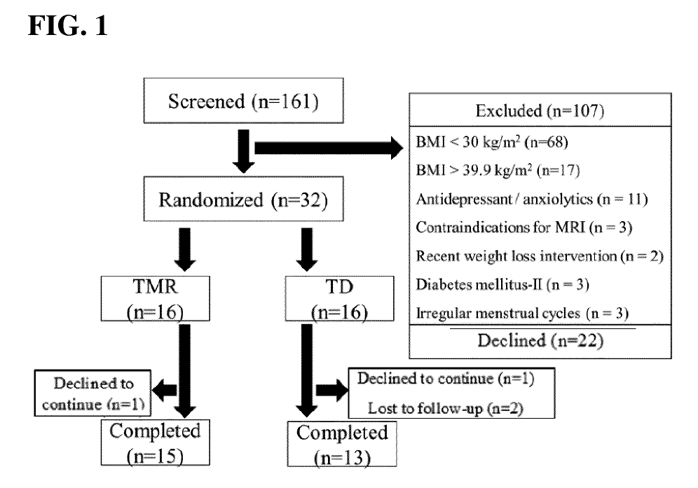

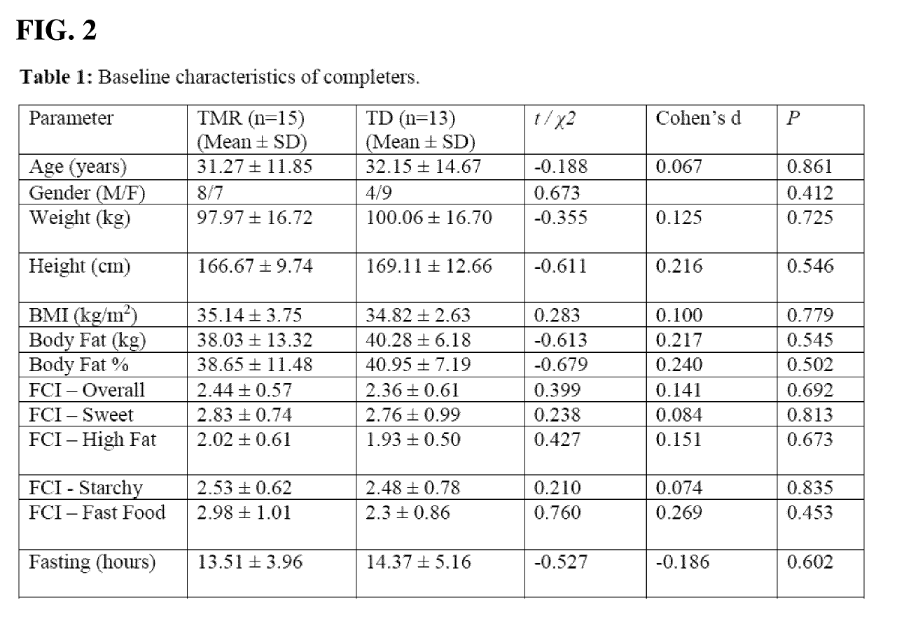

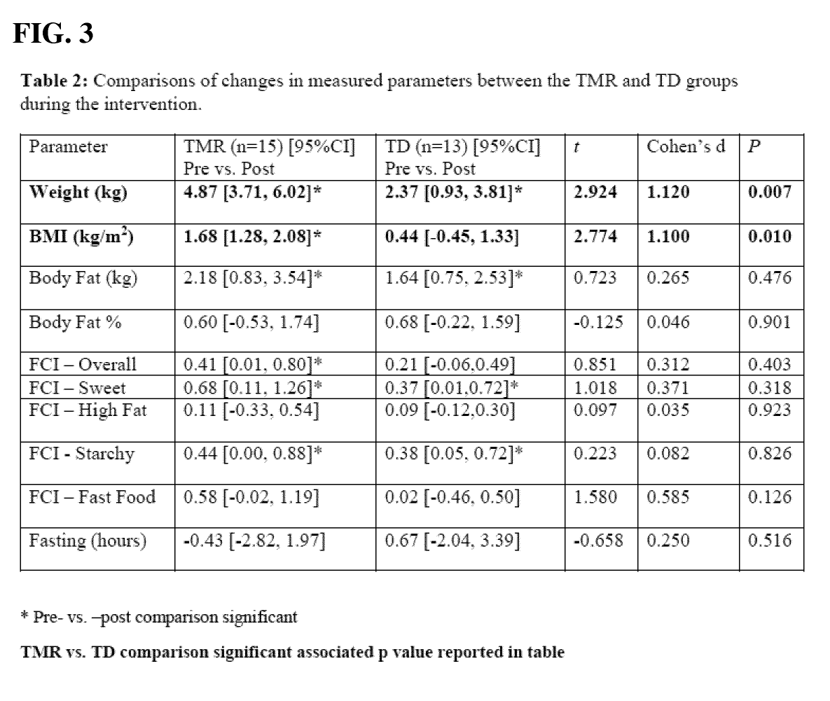

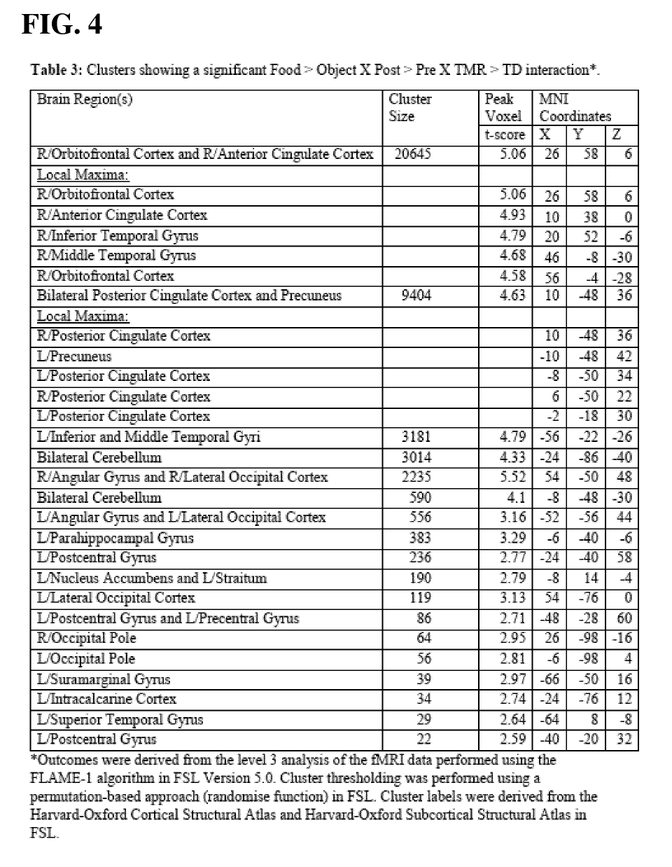

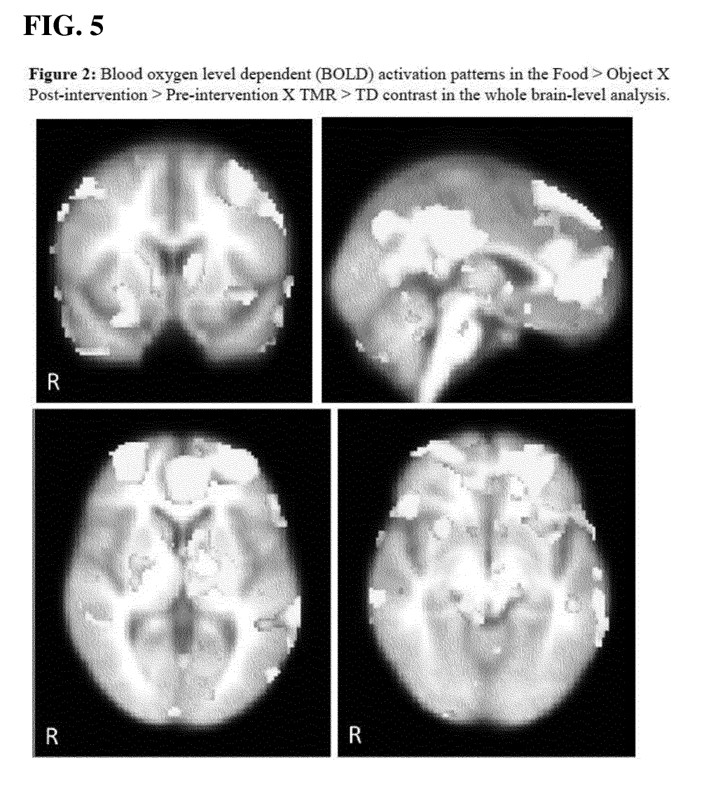

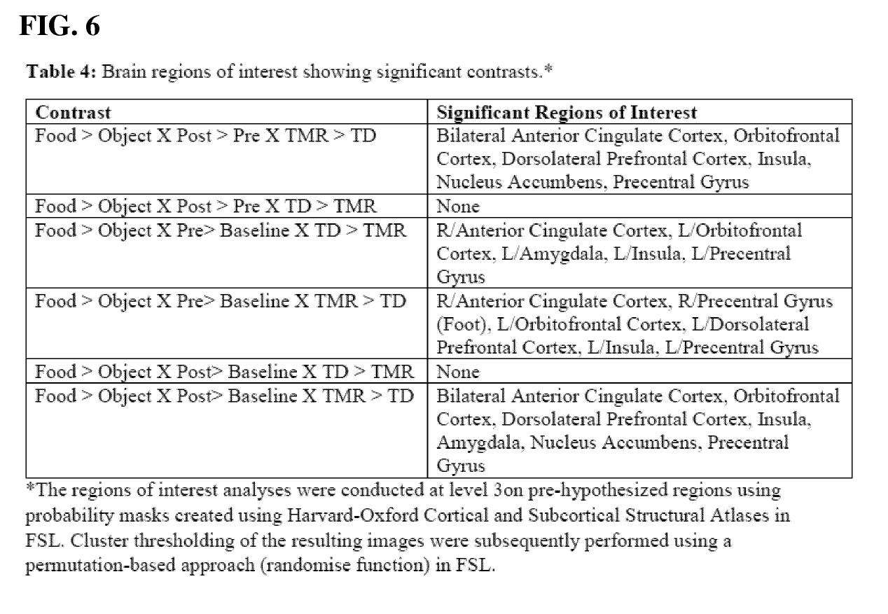

Fifteen and thirteen subjects in the TMR and TD groups completed the intervention respectively (see FIG. 1). The two groups did not differ by demographic or measured parameters at baseline (FIG. 2). Mean weight reduction by TMR (4.87 kg [3.71, 6.02]) was greater (P=0.007) than TD (2.37 kg [0.93, 3.81]; FIG. 3). Similarly, mean BMI reduction by TMR (1.68 kg/m2 [1.28, 2.08]) was greater (P=0.010) than TD (0.44 kg/m2 [−0.45, 1.33]). Only TMR significantly reduced overall cravings from baseline (0.41 [0.01, 0.8]). However, this reduction was not significantly different (P=0.403) compared with TD (0.21 [−0.06, 0.49]). Food>Object X Post>Pre X TMR>TD interaction was significant in bilateral dorsolateral prefrontal, orbitofrontal, anterior cingulate, insular and primary motor cortices and nucleus accumbens in the whole brain level analyses (FIGS. 4 and 5) as well as in pre-hypothesized region of interest analyses (FIG. 6) consistent with stronger food-cue reactivity in reward processing regions as well as increased executive control.

TMR increases the food-cue reactivity of the brain regions that regulate food reward compared to TD, but concurrent increases in the activity of regions that exert executive control were also noted. Thus the net short-term effect of TMR is a suppression of overall food cravings and also greater ultimate reduction in body weight and BMI compared to TD.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of reducing food cravings, promoting weight loss, and/or treating overweight or obesity in a human in need thereof, the method comprising orally administering meal replacements to the human each day of a time period comprising at least three weeks in an amount that provides a caloric intake of 800 to 1,500 kcal/day, the meal replacements are substantially the only food that contains calories consumed by the human during the time period, and each of the meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup.

2. The method of claim 1 wherein the human is overweight.

3. The method of claim 1 wherein the human is obese.

4. The method of claim 1 wherein the meal replacements are administered to the human in an amount that provides a caloric intake of 1,000 to 1,300 kcal/day during the time period.

5. The method of claim 1 wherein the time period in which the meal replacements are administered each day is at least one month.

6. The method of claim 1 wherein three to five of the meal replacements are administered to the individual daily during the time period.

7. The method of claim 1 wherein each of the meal replacements provides 100 to 300 kcal to the human.

8. The method of claim 1 wherein each of the meal replacements provides 8 to 30 g of protein to the human.

9. The method of claim 1 wherein each of the meal replacements provides 10 to 30 g of carbohydrate to the human.

10. The method of claim 1 wherein each of the meal replacements provides 2 to 5 g of fat to the human.

11. The method of claim 1 wherein each of the meal replacements provides to the human 10% to 40% of the RDI of each of vitamins and minerals comprising Vitamin A, Vitamin C, Calcium, Iron, Vitamin D, Vitamin E, Vitamin K, Thiamin, Riboflavin, Niacin, Vitamin B6, Folate, Vitamin B12, Biotin, Pantothenic Acid, Phosphorus, Iodine, Magnesium, Zinc, Selenium, Copper, Manganese, Chromium, Molybdenum, and Chloride.

12. The method of claim 11 wherein each of the meal replacements consists essentially of fat, protein, carbohydrates, the vitamins and the minerals.

13. A kit for reducing food cravings and/or narrowing food stimuli, the kit comprising separately packaged meal replacements, the kit further comprising instructions identifying a daily number of the separately packaged meal replacements to consume to provide a daily caloric intake of 800-1,500 kcal/day, and the kit comprises a number of the separately packaged meal replacements that is sufficient to provide the daily number of the separately packaged meal replacements for at least three weeks.

14. The kit of claim 13 wherein the number of the separately packaged meal replacements in the kit is sufficient to provide the daily number of the separately packaged meal replacements for at least one month.

15. The kit of claim 13 wherein the daily number of the separately packaged meal replacements to consume to provide the daily caloric intake of 800-1,500 kcal/day is in the range of three to five.

16. The kit of claim 13 wherein each of the separately packaged meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup.

17. The kit of claim 13 wherein each of the separately packaged meal replacements provides 100 to 300 kcal.

18. (canceled)

19. A method of promoting ingestive restraint and/or increased control over ingestive behavior, the method comprising orally administering meal replacements to a human each day of a time period comprising at least three weeks in an amount that provides a caloric intake of 800 to 1,500 kcal/day, the meal replacements are substantially the only food that contains calories consumed by the human during the time period, and each of the meal replacements has a form individually selected from the group consisting of a ready-to-drink beverage, a concentrate designed to be diluted to a beverage, a powder designed to be reconstituted as a beverage, a nutrition bar, a soup, a concentrate designed to be diluted to a soup, and a powder designed to be reconstituted as a soup.

20. (canceled)
